(19) United States
(12) Patent Application Publication
(10) Pub. No.: US 2018/0306350 A1
(43) Pub. Date: Oct. 25, 2018

(54) PIPE WITH SECURING PLATE

(71) Applicant: Jonathan A. Goubault, Mississauga (CA)

(72) Inventor: Jonathan A. Goubault, Mississauga (CA)

(21) Appl. No.: 15/958,069

(22) Filed: Apr. 20, 2018

Related U.S. Application Data
(60) Provisional application No. 62/488,097, filed on Apr. 21, 2017.

(51) Int. Cl. F16L 5/00

(52) U.S. Cl. CPC F16L 5/00

(57) ABSTRACT

An apparatus for transporting a fluid (such as water, gas, exhaust gas, sewage) from an interior of a structure to an exterior of a structure is provided. The apparatus includes a pipe and a plate fixedly attached to the pipe. The pipe passes through the planar face of the plate. The plate is configured to be secured to a surface of the structure.

### CROSS-REFERENCE TO RELATED APPLICATIONS

This application claims the benefit of U.S. Provisional Patent Application Ser. No. 62/488,097, filed Apr. 21, 2017, the complete disclosure of which is hereby expressly incorporated in its entirety herein by this reference.

### BACKGROUND OF THE INVENTION

Pipes used to transport a fluid (including, but not limited to, gases, exhaust gases, liquids, sewage, etc.) between an interior of a structure to an exterior of a structure are typically installed using a series of steps. For example, a sillcock (an example of such a pipe) is generally first put through an opening defined on the wall of a structure, then secured by securing the sillcock to a support structure that is separate from the pipe. For instance, an installer may be required to fabricate, on-site, a support structure for supporting the sillcock. An example of this is one or more lengths of pipe secured (e.g., nailed) across floor joists that supports, at least in part, the sillcock. To prevent movement and to reduce noise when water flows through the sillcock, the sillcock is commonly welded or otherwise secured to this on-site fabricated support. Since spacing between floor joists can vary, often the installer must cut a custom length of pipe to act as a fabricated support, adding to the installation time.

### SUMMARY OF THE INVENTION

The process of fabricating a support for the pipe is time consuming. By way of example, an installer must measure the distance between joists, cut one or more lengths of support pipe to secure between the joists, secure the one or more support pipes to the joists, run a pipe (that is supported by the support pipes) between the interior and exterior walls, then weld the pipe to the support pipes.

Once the pipe has been installed, the passageway between the interior and exterior wall must be sealed in order to prevent the exterior environment from entering the interior environment. Typically, material such as spray foam, caulk, concrete, or other such fillers are used, which can be time consuming, messy, and difficult to work with.

Furthermore, the fabrication process can cause damage to the area surrounding the fabricated support and pipe. For instance, the welding process can expose floor joists to high temperatures, increasing the risk of heat damage or fire damage to the area surrounding the fabricated support and pipe.

What is provided is an apparatus for transporting a fluid from an interior of a structure to an exterior of the structure. In an embodiment, the apparatus includes a plate fixedly attached to a pipe. The pipe passes through a planar face of the plate, and the plate is configured to be secured to a surface of the structure (including, but not limited to a rim joist, wall, etc).

The apparatus is ready to install without fabrication by the installer. In an embodiment, the installer passes one end of the pipe through a passageway (hole) defined in a structure so that the pipe passes between an interior and exterior of a structure. The installer then attaches the plate to the interior wall (or exterior wall, depending on the application) by using screws, nails, etc. with holes defined on the plate.

Once the apparatus has been installed, attachments such as valves, spigots, etc., can be attached to the ends of the pipe. Other lengths of pipe may also be attached or connected to the pipe.

Since the pipe is fixedly connected to the plate, the plate supports, at least in part, the pipe and prevents the pipe from moving or vibrating as a fluid flows through the pipe. No additional on-site fabrication is required by the installer to provide support for the pipe.

The plate also blocks, at least in part, the passageway once the apparatus is installed on the interior or exterior wall of the structure. Less material, then, is required to seal the passageway between the interior and the exterior wall of the structure. This can speed up the installation of the pipe as the installer needs less time and effort to seal the passageway between the interior wall and exterior wall of the structure.

In another embodiment an apparatus comprising a pipe for transporting a fluid from an interior of a structure to an exterior of the structure is provided. A plate is fixedly connected to the pipe. The pipe passes through a planar face of the plate, and the plate is securable to a surface of the structure.

### BRIEF DESCRIPTION OF THE DRAWINGS

FIG. 1 (SHEET 1/9) depicts a perspective view of an embodiment of the apparatus.

FIG. 2 (SHEET 2/9) depicts a front view of an embodiment of the apparatus of FIG. 1.

FIG. 3 (SHEETS 3/9) depicts a side view of an embodiment of the apparatus of FIG. 1.

FIG. 4A and FIG. 4B (SHEET 4/9 and SHEET 5/9) depict an alternate embodiment of the apparatus.

FIG. 5 (SHEET 6/9) depicts a side view of an embodiment of FIG. 1 as used in a structure.

FIG. 6 (SHEET 7/9) depicts an embodiment of the apparatus.

FIG. 7 (SHEET 8/9) depicts a side view of an embodiment of FIG. 6 as used in a structure.

FIG. 8 (SHEET 9/9) depicts a side view of an embodiment of FIG. 6 as used in a structure.

### LISTING OF REFERENCE NUMERALS USED IN THE DRAWINGS

100—Pipe

102—Plate

104—Receiver for Fastener

106—Weld

200—Fastener

204—Exterior

206—Interior

300—longitudinal axis of pipe

302—planar axis of plate

### DETAILED DESCRIPTION OF THE NON-LIMITING EMBODIMENTS

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of the invention is defined by the claims. For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the invention is limited to the subject matter provided by the claims, and that the invention is not limited to the particular aspects depicted and described.

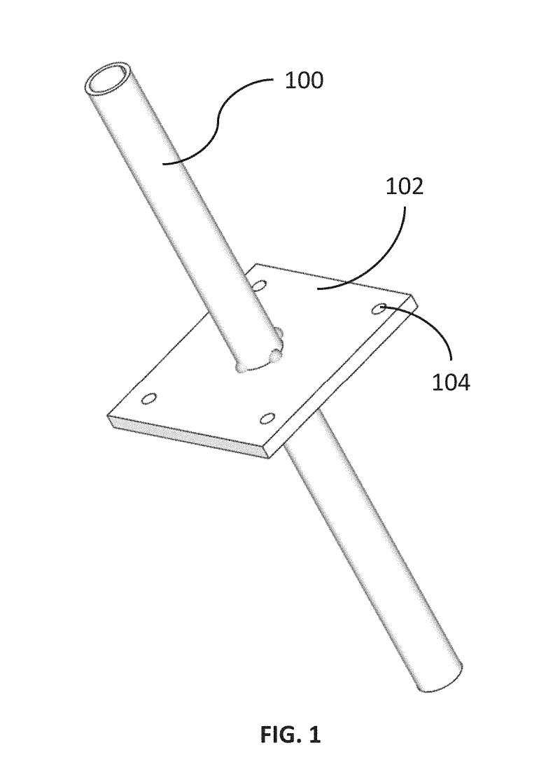

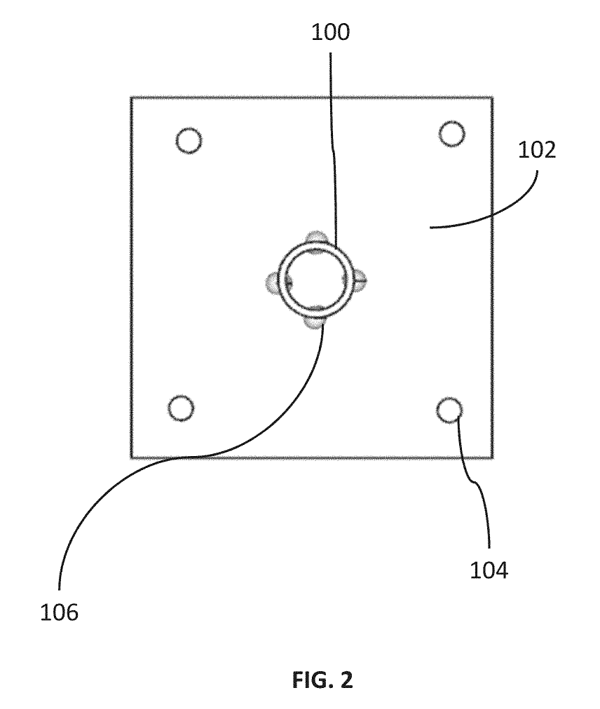

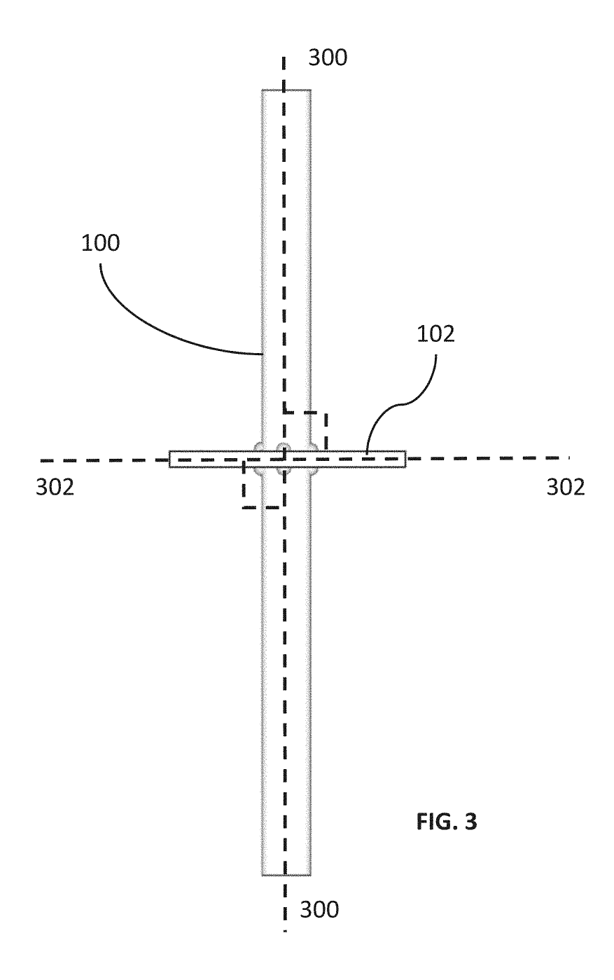

Referring to FIG. 1, FIG. 2, and FIG. 3 a perspective, front, and side view respectively of an embodiment of the apparatus is depicted. In this embodiment the apparatus includes a pipe 100 for transporting a fluid, gas, and/or exhaust. The fluid may be water, sewage, natural gas, gas, exhaust (such as the products of combustion), or any other fluid-like material that may flow through a pipe 100.

The pipe 100 may be made of any rigid or semi-rigid material including, but not limited to, metal (such as copper, galvanized steel, iron, etc.), plastic (such as ABS, PVC, etc.), glass, flexible braided flex lines, etc. Examples of pipes include, but are not limited to, ½ inch copper pipe, ¾ inch copper pipe, 1 inch copper pipe, 1½ inch ABS, 2 inch SYSTEM 636 (TRADEMARK) PVC and CPVC, and/or 3 inch SYSTEM 636 (TRADEMARK) PVC and CPVC.

For instance, for irrigation lines a ¾ inch or 1 inch copper pipe is typically used. For applications such as furnace exhausts, hot water tank exhausts, a 2 inch or 3 inch SYSTEM 636 (TRADEMARK) pipe is typically used. For other uses, such as sump pumps, a 1½ inch ABS pipe may be used. It will be appreciated that the material used for the pipe will depend on the application for which it is being used, as well as local building codes.

It will be appreciated that the material, dimension, pressure rating, corrosion resistance, and other characteristics of the pipe 100 may depend on the application. For instance, in a non-limiting example where the pipe is used to transport water, copper plumbing pipe may be used. In another non-limiting example where the pipe is intended for the transport of natural gas, a natural gas pipe may be used.

The pipe 100 is configured to transport the fluid from an interior 206 of a structure to an exterior 204 of the structure. In some embodiments the pipe 100 is configured to transport fluid from the inside of a building such as a house, apartment building, office building, supply shed, etc. to the outside of the building (or vice-versa). In other embodiments the pipe 100 may be used to transport fluid from the inside of a structure such as a water fountain, water feature, etc.to the outside of the structure (or vice-versa).

In this embodiment the apparatus further includes a plate 102 fixedly attached to the pipe 100. The pipe 100 passes through a planar face of the plate 102. The plate 102 may be made of any rigid or semi-rigid material including, but not limited to, metal (such as copper, galvanized steel, iron, etc.), plastic (such as ABS, PVC, etc.), glass, etc. In some non-limiting embodiments the plate 102 may be made of the same, similar, or complementary material as the pipe 100. By way of non-limiting example, in some embodiments both the plate 102 and the pipe 100 may be made of copper.

In other non-limiting embodiments it may be more suitable for the plate 102 to be made of a different material than the pipe 100. For example, in some embodiments the plate 102 may be a different metal than the pipe 100 to mitigate the effects of galvanic corrosion on the pipe 100, the plate 102, or both. An example would include, but is not limited to, using a plastic (ABS, etc) plate with a copper pipe to avoid issues with galvanic corrosion.

In the embodiment depicted in the figures the plate 102 is a square shaped. It was determined that a square shape allows for the plate to be placed between wall studs/floor joists of varying widths during installation. It will appreciated that other plate shapes can be used without departing from the scope of this disclosure. For example, in some embodiments the plate may be oval shaped, rectangular shaped, circle shaped, hexagonal shaped, or any other suitable shape for a plate.

The plate is configured so that the pipe 100 passes through the planar face of the plate 102. In some embodiments the plate 102 may define, on its planar face, an opening so that a pipe 100 may pass through the opening.

In this embodiment the pipe 100 may be fixedly attached to the plate 102 once the pipe 100 has been positioned in, and passes through at least in part, the opening defined by the plate 102. The pipe 100 is then fixedly attached to the plate 102 so that the pipe 100 does not move relative to the plate 102. The pipe 100 may not be removed once the pipe 100 is fixedly attached to the plate 102. That is, the pipe 100 is permanently and fixedly attached to the plate 1002.

In this embodiment the plate 102 is welded 106 to the pipe 100 (or vice versa). It will be appreciated that other ways of fixedly attaching the plate 102 to the pipe 100 (or vice versa) can be used depending on the application. For instance, in a non-limiting embodiment where PVC pipe and a PVC plate is used, the PVC pipe may be fixedly attached to the PVC plate using an adhesive such as glue or epoxy. Other ways of fixedly attaching the plate 102 to the pipe 100 include soldering, brazing, etc.

In another example embodiment, the pipe 100 and plate 102 may be manufactured as a single unit. That is, the plate 102 and the pipe 100 are a single piece. For instance, the pipe 100 and plate 102 assembly may be cast, extruded, or otherwise manufactured in such a way so that the plate 102 is integrated into the pipe 100 (e.g., as a flange or fin). In another example where the apparatus is made of PVC or a similar plastic, the apparatus may be blow molded, cast, or shaped in in such a way so that the plate 102 is integrated into the pipe 100 (e.g., as a flange or fin).

The plate 102 is also configured to be secured to a surface of the structure. In the embodiment depicted in FIG. 1 the plate 102 is configured to receive securing devices, fasteners, attachment means, or the like for attaching the plate 102 to a surface. In this embodiment, the plate 102 defines one or more openings through which an attachment device can be used to secure the plate 102 to the surface. Examples include, but are not limited to, nails, screws, staples, rivets, bolts (and associated nuts), glue, and spikes. In the embodiment where screws are used to secure the plate 102 to the surface, the plate can be referred to as a screw flange.

It will be appreciated once the plate 102 is secured to the surface of the structure, the pipe will extend between an interior of the structure to an exterior of the structure through an opening defined in the structure. No additional support is necessary to support the pipe 100 of the apparatus. Furthermore, in comparison with the installation of prior-art sillcocks, installation of the apparatus is simplified. That is, a user needs only to secure the plate 102 to the surface of the structure to install the apparatus.

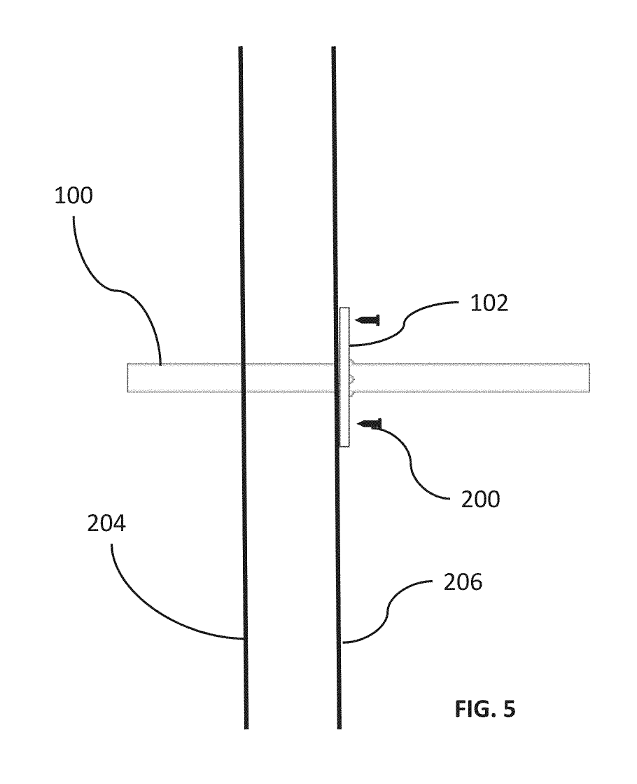

Referring now to FIG. 5 (SHEET 6/9) a side view of an embodiment of FIG. 1 as used in a non-limiting example structure is depicted. In this embodiment the openings 104 defined on the planar face of the plate 102 are configured so that a head of the attachment device 200 (e.g., a screw head or a nail head) cannot pass through the opening, thereby securing the plate 102 to the surface once the plate 102 has been secured to the surface by the attachment device 200. It will be appreciated that the openings 104 defined on the planar face of the plate 102 may be configured in order to be secured to the surface of a structure by any known attachment device means. Examples attachment devices 200 include, but are not limited to, screws, screws with washers, nails, bolts, rivets, studs, adhesives, etc.

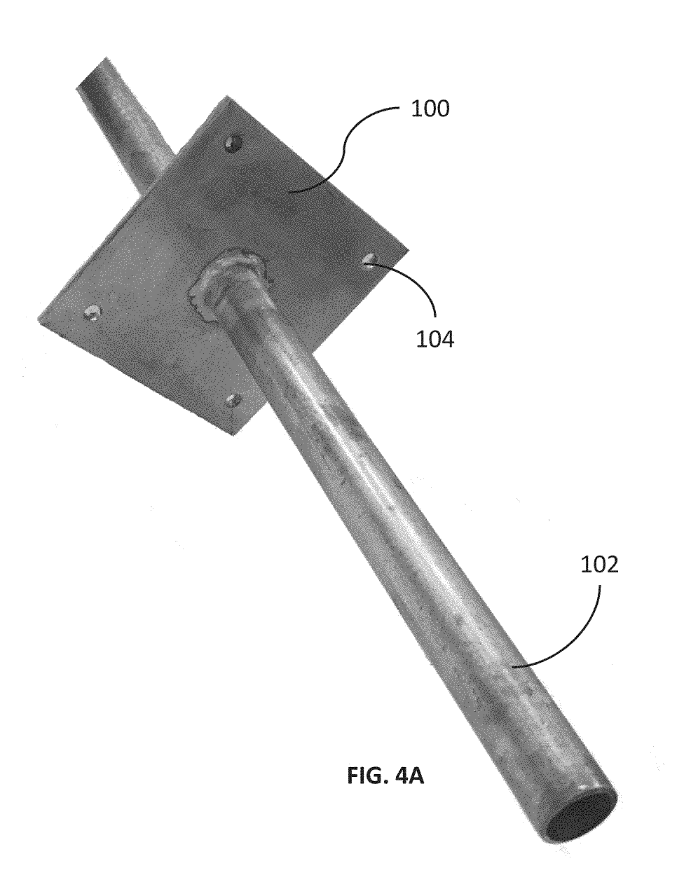

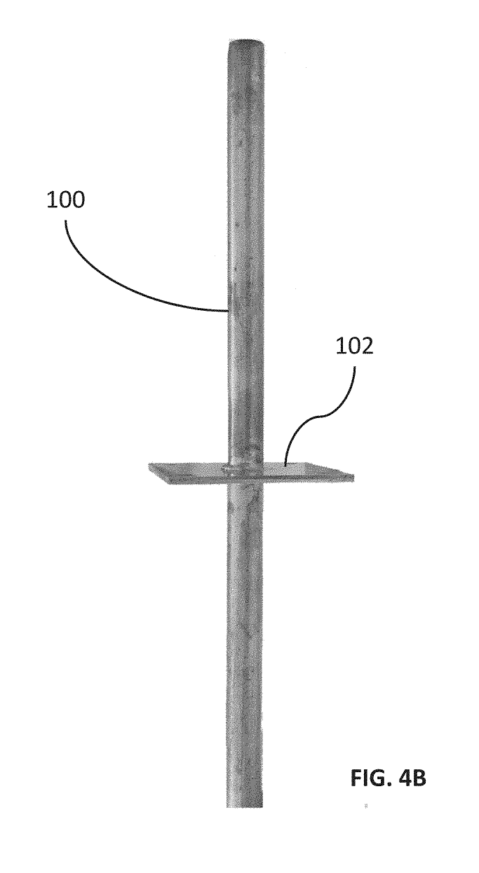

In the embodiment depicted in FIGS. 4A and 4B, the pipe 100 and plate 102 are made of copper. The plate 102 is square shaped and made of a square copper plate approximately ¼ inch thick. The pipe 100 is a ½ inch copper pipe commonly used to transport water in a residential setting. The pipe 100 is secured to the plate 102 by welding. Openings 104 are defined on the planar face of the plate 102 so that the plate can be secured to an interior or exterior wall of a structure. In this embodiment the openings are sufficiently sized so that wood screws can be used to secure the plate 102 (alternately referred to as a screw flange in this embodiment) to a wall structure such as (for example) a wooden bottom plate, one or more studs, or an interior or exterior wall.

In the embodiment depicted in FIG. 5 (SHEET 6/9) the apparatus is configured to be attached to an interior 206 of a structure. In this example the apparatus is intended to be used as a sillcock. That is, the apparatus is configured to transport water from an interior 206 of a structure to an exterior 204 of a structure. The pipe must pass through an opening defined in the interior/exterior wall of the structure. In this example the apparatus is configured to be secured to an interior wall 206 of a structure (including, but not limited to, rim joists, supports, studs, wall plates, walls, etc). The plate 102 is configured to be secured to the interior wall 206 of the structure (including, but not limited to, rim joists, supports, studs, wall plates, walls, etc) using any of the means described earlier, such as by nailing, screwing, riveting, gluing, etc.

It will be appreciated that the apparatus can be used with any structure that requires a fluid to be transported from an interior of the structure to an exterior of the structure. Non-limiting examples of structures include houses, office towers, sheds, water fountains, etc.

The apparatus may also be configured to be used with accessories. Non-limiting examples of accessories include, but are not limited to, hose bibs, valves, pipe connectors, joints, etc. For example, in some embodiments the pipe 100 may be threaded so that accessories such as hose bibs, valves, connectors, etc can be attached to the ends of the pipe 100. In other examples the ends of the pipe 100 may include proprietary fasteners such as quick release fasteners, etc. so that hoses can be quick-connected to the pipe. In yet another example, accessories may be attached using adhesives, soldering, welding, crimping, friction fitting, or any other means of attaching accessories to pipes.

In the embodiments depicted in FIG. 1 to FIG. 3 the pipe 100 is configured so that it is approximately normal to the planar face of the plate 102. That is, the angle between a longitudinal axis of the pipe 100 and the axis of the planar face of the plate 102 is approximately 90 degrees (as depicted in FIG. 3). It will be appreciated, however, that the angle between a longitudinal axis of the pipe 100 and the axis of the planar face of the pipe 102 can be less than or greater than 90 degrees depending on usage requirements.

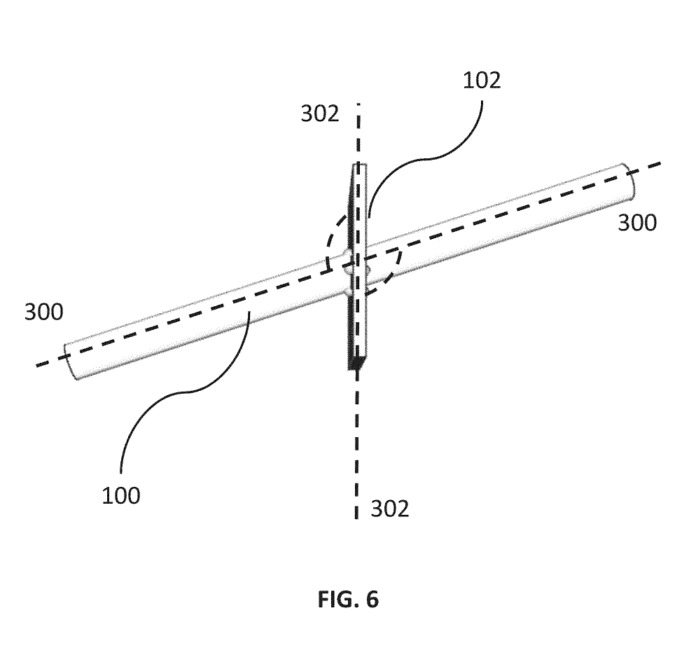

For instance, FIG. 6 (SHEET 7/9) depicts an alternate embodiment of the apparatus. In this embodiment the angle between the longitudinal axis of the pipe 100 and an axis of the planar face of the plate 100, on the interior side, is greater than 90 degrees. It will be understood that the adjacent angle on the exterior side of the plate will be 180 degrees minus the interior angle so that the sum of the adjacent angles is 180 degrees. Likewise, the complementary angle on the exterior side of the plate will be the same angle as the interior angle. This is because the pipe is straight. In the case where a non-straight pipe is used, the adjacent and/or complementary angle may be different.

In some embodiments the angle between the longitudinal axis of the pipe 100 and the axis of the planar face of the plate 100 will be determined by, among other things, the intended use of the apparatus and local building codes and/or regulations. For example, in some embodiments the angle between the longitudinal axis of the pipe 100 and the axis of the planar face of the plate 100 will be determined by a specific slope value. An example of this is for an apparatus of this disclosure configured for use as an exhaust flue for a water heater which has slope of 0.25 inches per foot (12 inches) towards the interior of the structure.

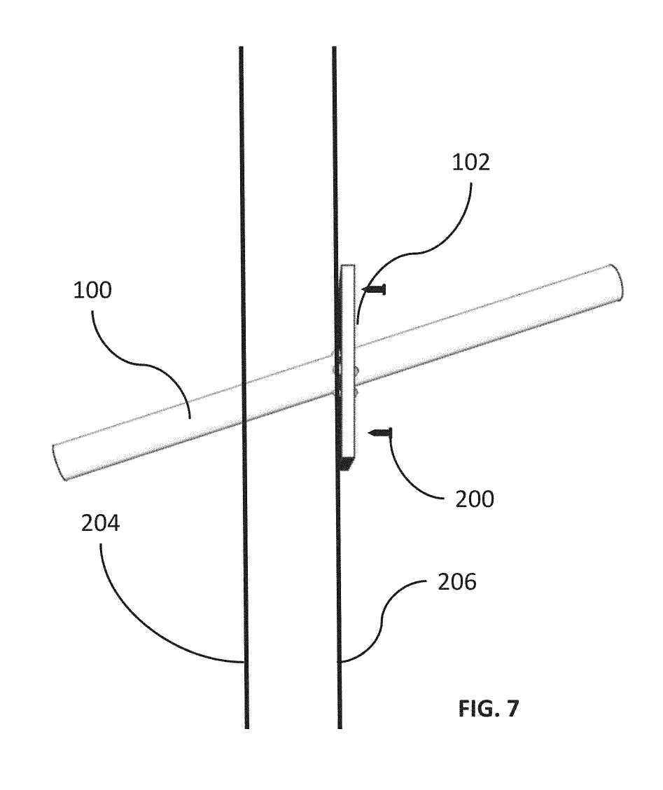

FIG. 7 (SHEET 8/9) depicts a side view of an embodiment of FIG. 5 as used in a structure. In this example the pipe 100 is angled relative to the plate 102 so that the fluid (such as a liquid, exhaust gas, etc.) being transported is assisted, at least in part, by gravity. This may be useful in scenarios where the pipe must be drained on a regular basis. That is, the angle of the pipe can help to avoid situations where some fluid remains in the pipe after the fluid has been transported from an interior of the structure to an exterior of the structure. In this example the pipe 100 is configured to drain out of the interior of the structure.

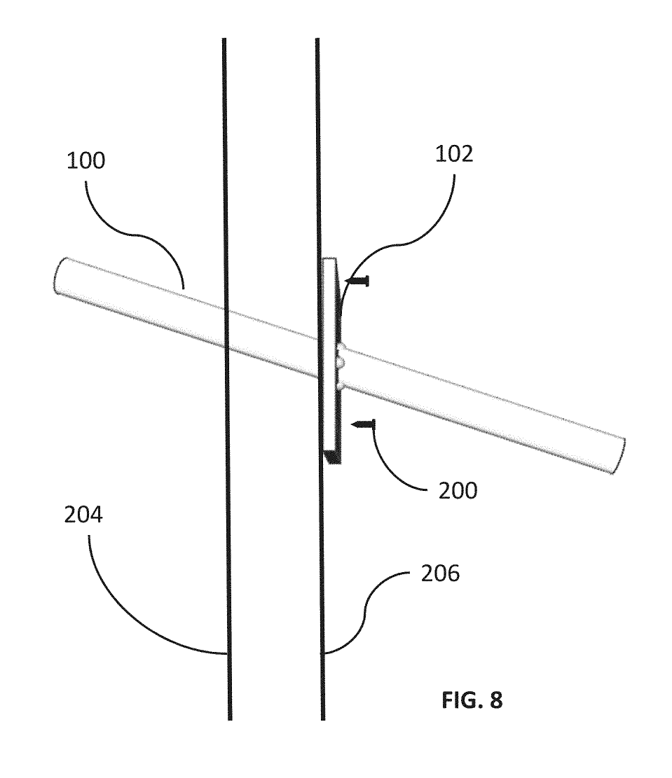

FIG. 8 (SHEET 9/9) depicts a side view of an embodiment of FIG. 5 as used in a structure. In this example the pipe 100 is angled relative to the plate 102 so that the fluid being transported is assisted, at least in part, by gravity. This may be useful in scenarios where the pipe must be drained on a regular basis. That is, the angle of the pipe can help to avoid situations where some fluid remains in the pipe after the fluid has been transported from an interior of the structure to an exterior of the structure. In this example the pipe 100 is configured to drain into the interior of the structure.

This written description uses examples to disclose the invention, including the best mode, and also to enable any person skilled in the art to make and use the invention. The patentable scope of the invention is defined by the claims, and may include other examples that occur to those skilled in the art. Such other examples are within the scope of the claims if they have structural elements that do not differ from the literal language of the claims, or if they include equivalent structural elements with insubstantial differences from the literal language of the claims.

It will be appreciated that the assemblies and modules described above may be connected with each other as required to perform desired functions and tasks within the scope of persons of skill in the art to make such combinations and permutations without having to describe each and every one in explicit terms. There is no particular assembly or component that may be superior to any of the equivalents available to the person skilled in the art. There is no particular mode of practicing the disclosed subject matter that is superior to others, so long as the functions may be performed. It is believed that all the crucial aspects of the disclosed subject matter have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) the description provided outside of this document (that is, outside of the instant application as filed, as prosecuted, and/or as granted). It is understood, for this document, that the phrase “includes” is equivalent to the word “comprising.” The foregoing has outlined the non-limiting embodiments (examples). The description is made for particular non-limiting embodiments (examples). It is understood that the non-limiting embodiments are merely illustrative as examples.

1. An apparatus comprising:
a pipe for transporting a fluid from an interior of a structure to an exterior of the structure; and
a plate fixedly connected to the pipe;
wherein the pipe passes through a planar face of the plate and is securable to a surface of the structure.

2. The apparatus of claim 1, wherein the plate is welded to the pipe.

3. The apparatus of claim 1, wherein the plate is glued to the pipe.

4. The apparatus of claim 1, wherein the plate is soldered to the pipe.

5. The apparatus of claim 1, wherein the plate is brazed to the pipe.

6. The apparatus of claim 1, wherein the pipe and the plate are manufactured as a single unit.

7. The apparatus of claim 1, wherein the plate is securable to the interior of the structure.

8. The apparatus of claim 7, wherein the plate is screwed into the interior of the structure.

9. The apparatus of claim 7, wherein the plate is glued to the interior of the structure.

10. The apparatus of claim 7, wherein the plate is nailed to the interior of the structure.

11. The apparatus of claim 1, wherein the fluid is any one of a liquid or a gas.

12. The apparatus of claim 1, wherein the plate and the pipe are made of the same material.

13. The apparatus of claim 1, wherein the plate and the pipe are made of different materials.

14. The apparatus of claim 1, wherein the pipe is normal to the face of the plate.

15. The apparatus of claim 1, wherein the pipe is angled relative to the face of the plate.

16. The apparatus of claim 1, wherein the pipe is angled relative to the plate so that the fluid being transported is assisted by gravity.

17. The apparatus of claim 1, wherein the pipe includes threads at a first end of the pipe and a second end of the pipe, the threads being configured to attach to a plumbing accessory.

18. The apparatus of claim 16, wherein the plumbing accessory is any one of another pipe, a pipe connector, or a hose bib.

19. The apparatus of claim 1, wherein the structure is a building.

20. The apparatus of claim 1, wherein the apparatus is installable without on-site fabrication by an installer.
